(19) United States
(12) Patent Application Publication
(10) Pub. No.: US 2024/0249289 A1
(43) Pub. Date: Jul. 25, 2024

(54) System and Method for Securing a Non-Fungible Digital Asset

(71) Applicant: Frontage Road Holdings, LLC, Wilmington, DE (US)

(72) Inventor: Raymond A. Chiapuzio, Eugene, OR (US)

(21) Appl. No.: 18/417,158

(22) Filed: Jan. 19, 2024

Related U.S. Application Data
(60) Provisional application No. 63/481,116, filed on Jan. 23, 2023.

(51) Int. Cl. G06Q 20/40; G06Q 20/38; H04L 9/00

(52) U.S. Cl. CPC G06Q 20/4016; G06Q 20/3825; H04L 9/008; H04L 9/50; H04L 2209/46

(57) ABSTRACT

A computer-based system, computer-implemented method, and computer program product for securing a non-fungible digital asset leverage a multiparty computation (MPC) security system implemented upon one or more blockchain computer networks. The MPC security system is configured to implement a secure binding between a cryptographic key and a non-fungible digital asset. The MPC security system is further configured to computationally process shard(s) of the cryptographic key by assigning the shard(s) to respective node(s) of the multiple nodes. The MPC security system is further configured to computationally pair the respective node(s) with the MPC security system. The MPC security system is further configured to verify secure possession of each of the shard(s) by each corresponding node of the node(s). The MPC security system is further configured to, responsive to the verifying, approve a transaction for the asset, the transaction occurring among at least two of the multiple nodes, thereby securing the asset.

### RELATED APPLICATION

This application claims the benefit of U.S. provisional application Ser. No. 63/481,116, filed on Jan. 23, 2023. The entire teachings of the above application are incorporated herein by reference.

### BACKGROUND

A blockchain may be implemented as a peer-to-peer (P2P), electronic ledger that is implemented as a computer-based decentralized, distributed system made up of blocks, which, in turn, are made up of transactions. Each transaction may be a data structure that encodes a transfer of control of a digital asset between participants in the blockchain system, and that includes at least one input and at least one output. Each block may contain a hash of a previous block so that blocks become chained together to create a permanent, unalterable record of all transactions that have been written to the blockchain since its inception. Transactions may contain small programs, known as scripts, embedded into their inputs and outputs; the scripts may specify how and by whom the outputs of the transactions can be accessed.

Blockchain may be used for implementation of “smart contracts” that can be associated with digital asset. These are computer programs designed to automate execution of terms of a machine-readable contract or agreement. Unlike a traditional contract, which would be written in natural language, a smart contract is a machine-executable program that may include rules for processing inputs to generate results; these results may then cause actions to be performed depending upon those results. With respect to commercial transactions, for example, these may involve a transfer of property rights and/or assets.

An area of blockchain-related interest is the use of “tokens” to represent and transfer assets via the blockchain. A token serves as an identifier that allows an asset to be referenced from the blockchain. Fungible tokens are uniform. In other words, fungible tokens of the same type are identical in specification, and each fungible token is identical to another fungible token of the same type. Fungible tokens may be divisible into smaller amounts. Similar to currency, where bills can be divided into coins of an equivalent value, fungible tokens may be divisible. Non-fungible tokens (NFTs), however, cannot be replaced with other tokens of the same type. NFTs represent non-fungible assets. Non-fungible assets have unique information or attributes. Each NFT is unique and differs from other tokens of the same class, and, unlike a fungible token, NFTs typically cannot be divided. Blockchain gaming systems may use tokens or NFTs to create different parts of the game, such as rules, characters, weapons, and skins.

Cryptocurrency wallets may be implemented to securely store and manage blockchain assets, tokens, NFTs, and cryptocurrencies. These wallets may allow users to spend, receive, and trade digital assets.

### SUMMARY

Embodiments offer solutions that can improve security in cryptocurrency asset storage, management, and transfer. Certain embodiments include features that leverage multiparty computation (MPC) techniques to enable multiple parties to make calculations using their combined data, without revealing their individual inputs. Some embodiments can execute a

MPC security system that provides flexibility in managing access and control of digital assets that are shared, controlled, and/or owned by multiple users. Further, it is desirable to enable computations using combined data of multiple users, without revealing their individual inputs.

Embodiments thus include a computer-based system for securing a non-fungible digital asset. In an example embodiment, the system includes a blockchain computer network with multiple nodes. A node of the multiple nodes of the blockchain computer network may be configured to execute a MPC security system. The MPC security system may be configured to implement a secure binding between a cryptographic key and a non-fungible digital asset. The MPC security system may be further configured to computationally process shard(s) of the cryptographic key by assigning the shard(s) to respective node(s) of the multiple nodes. The MPC security system may be further configured to computationally pair the respective node(s) with the multiparty MPC security system. The MPC security system may be further configured to verify secure possession of each shard of the shard(s) by each corresponding node of the respective node(s). The MPC security system may be further configured to, responsive to the verifying, approve or validate a transaction for the non-fungible digital asset. The transaction may occur among at least two of the multiple nodes. The MPC security system thereby secures the non-fungible digital asset.

According to an example embodiment, the non-fungible digital asset may be a non-fungible token (NFT).

In an example embodiment, the multiple nodes may be configured to operate in connection with each other in the blockchain computer network. According to another example embodiment, the system may include an additional blockchain computer network. The transaction may be configured to perform a cross-chain transfer of the non-fungible digital asset between the blockchain computer network and the additional blockchain computer network.

According to an example embodiment, a first node of the multiple nodes may be configured to request access to a shard of the shard(s). A second node of the multiple nodes may be configured to delegate access to the shard to the first node. In another example embodiment, the second node may be configured to manage access to the shard to which the first node is configured to request access. Further, in yet another example embodiment, the first node may be a client device configured to interface with an online gaming environment.

In an example embodiment, the transaction may be a first transaction. The MPC security system may be further configured to detect an indication of fraud in a second transaction for the non-fungible digital asset. According to another example embodiment, the MPC security system, upon detecting the at least one indication of fraud, may be further configured to preempt the second transaction verify the cryptographic key securely bound with the non-fungible digital asset. The shard(s) may include at least three shards associated with at least three respective nodes of the multiple nodes. Further, in yet another example embodiment, the at least three respective nodes may include a wallet node, a user node, or a compliance node.

According to an example embodiment, the node of the multiple nodes of the blockchain computer network may include a secure cryptoprocessor implemented as a dedicated microprocessor configured to execute the MPC security system. The MPC security system may be embedded on the secure cryptoprocessor.

Alternative computer-implemented method and computer program product embodiments parallel those described above in connection with the example computer-based system embodiments.

It should be understood that example embodiments disclosed herein can be implemented in the form of a computer-implemented method, apparatus, computer-based system, or computer program product.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of an example embodiment of a system for securing a non-fungible digital asset.

FIG. 2 is a block diagram of an example user identification system according to an embodiment.

FIG. 3 is a block diagram of an example embodiment of a distributed blockchain ledger computer-implemented system.

FIG. 4 is a block diagram showing exemplary blockchain layers according to an embodiment.

FIG. 5 is a block diagram of an example implementation of a network in communication with an embodiment.

FIG. 6 is a block diagram of any internal structure of a computer/computing node in a processing environment of an embodiment.

FIG. 7A is a block diagram showing an example multiparty computation (MPC) locker system according to an embodiment.

FIG. 7B is a diagram showing example system components for the example MPC locker system according to an embodiment.

FIG. 7C is a diagram of an example device authentication system coupled with the example system components according to an embodiment.

FIG. 7D is a diagram of an example MPC locker authentication system adapter and its outward and inward-looking interfaces according to an embodiment.

FIG. 8A is a diagram of an example sequence of packaging and delivering an instruction by an example MPC locker system according to an embodiment.

FIG. 8B is a diagram of an example device enrollment process for the example MPC locker system according to an embodiment.

FIG. 9 is a flow diagram of an exemplary computer-based system/method for securing a non-fungible digital asset according to an embodiment.

### DETAILED DESCRIPTION

A description of example embodiments follows.

In general, blockchain is a write-once, append-many type electronic ledger. Blockchain is an architecture that allows disparate users to make transactions and creates an unchangeable record of those transactions. To move anything of value over any kind of blockchain, a network of nodes must first agree that a corresponding transaction is valid. As a peer-to-peer (P2P) network, combined with a distributed time-stamping server, blockchain ledgers can be managed autonomously to exchange information between disparate parties; there is no need for an administrator. In effect, the blockchain users are the administrator.

Blockchain's rapid development has given rise to many different kinds of chains, leading to cross-chain technology. Cross-chain, as its name suggests, allows the transmission of value and information between different blockchains. According to an example embodiment, a digital asset may be exchanged, cross-chain, securely, and despite differences between constraints or rules of operation that may be established for the different blockchains. Such a digital asset may be in the form of a token, which may be fungible, or may be a non-fungible token (NFT). Such constraints or rules may be in the form of smart contracts, or other forms. Differences between such constraints or rules may include disparate levels of rigor or leniency of such constraints or rules between or among different blockchain networks.

In some embodiments, blockchain may be a P2P, electronic ledger that is implemented as a computer-based decentralized, distributed system made up of blocks, which, in turn, are made up of transactions. Each transaction may be a data structure that encodes a transfer of control of a digital asset between participants in the blockchain system, and that includes at least one input and at least one output. Each block may contain a hash of a previous block so that blocks become chained together to create a permanent, unalterable record of all transactions that have been written to the blockchain since its inception. Transactions may contain small programs, known as scripts, embedded into their inputs and outputs; the scripts may specify how and by whom the outputs of the transactions can be accessed.

For a transaction to be written to the blockchain, it must be “validated.” Network nodes (miners) may perform work to ensure that each transaction is valid, with invalid transactions being rejected from the network. Software clients installed on the nodes may perform this validation work on an unspent transaction (UTXO) by executing its locking and unlocking scripts. If execution of the locking and unlocking scripts evaluates to TRUE, the transaction is valid and is written to the blockchain. Thus, for a transaction to be written to the blockchain, it should be: (i) validated by a first node that receives the transaction—e.g., if the transaction is validated, the node relays it to other nodes in the network; (ii) added to a new block built by a miner; and (iii) mined, e.g., added to the public ledger of past transactions.

Blockchain may be used for implementation of “smart contracts” that can be associated with digital assets. These are computer programs designed to automate execution of terms of a machine-readable contract or agreement. Unlike a traditional contract, which would be written in natural language, a smart contract is a machine-executable program that may include rules for processing inputs to generate results; these results may then cause actions to be performed depending upon those results. With respect to commercial transactions, for example, these may involve a transfer of property rights and/or assets. Such assets may include real property, personal property (including both tangible and intangible property), digital assets such as software, or any other type of asset. In the digital economy, there is often an expectation that exchanges and transfers will be performed in a timely manner and across vast distances. This expectation, along with practical, technical limitations, means that traditional forms of asset transfer, such as physical delivery of hardcopy of documents representing a contract, negotiable instrument, etc., or a tangible asset itself, are not desirable. Thus, smart contracts can provide enhanced control, efficiency, and speed of transfer.

An area of blockchain-related interest is a use of “tokens” to represent and transfer assets via the blockchain. A token thus serves as an identifier that allows a real-world item to be referenced from the blockchain. Through an initial coin offering (ICO) model, startups may raise capital by issuing tokens on a blockchain, such as Ethereum, and distributing them to token buyers in exchange for making a financial contribution to a project. These tokens, which may be transferred across a network and traded on cryptocurrency exchanges, may serve a multitude of different functions, from granting holders access to a service to entitling them to company dividends. Depending on their function, tokens may be classified as security tokens or utility tokens.

Further, similar to physical assets, the tokens that represent them may have many properties, one of which is fungibility or non-fungibility. In economics, fungibility refers to equivalence or interchangeability of each unit of a commodity with other units of the same commodity. Fungible tokens (FTs) are tokens that can be exchanged for any other token with the same value.

Fungible tokens are uniform, that is, FTs of the same type are identical in specification. In other words, each FT is identical to another FT of the same type, and FTs are divisible into smaller amounts Similar to currency, where bills can be divided into coins of an equivalent value, FTs are divisible. As such, a fraction of an FT can be transferred between users. NFTs, however, cannot be replaced with other tokens of the same type. NFTs represent nonfungible assets, e.g., assets that have unique information or attributes. Each NFT is unique and differs from other tokens of the same class. For example, while plane tickets from and to a same destination may look the same, each one has a different passenger name, seat number, etc., and, therefore, is unique. In contrast to FTs, NFTs usually cannot be divided, so a basic or elementary unit of a NFT is the token itself. However, fractional ownership of NFTs is also possible. Fractional ownership allows a NFT to be divided into smaller NFTs.

Due to an immutable nature of transaction histories supported by blockchain networks, it is possible to extend the aforementioned validation steps of such transactions so that the transactions become subject to certain rules that reference prior transactions, or even aspects of an initial creation of a subject digital asset, e.g., a NFT. An example of such rules is an arrangement wherein royalties are paid to a creator of a digital asset each time the digital asset is sold to a subsequent owner. Such royalty payment arrangements may be implemented as a function with which the blockchain network is programmed, or using a reference table loaded into a computer memory element of the blockchain network, as a smart contract as described hereinabove, or by other means.

A further use case for cryptocurrency exchanges on a blockchain network is that such exchanges can protect transactions—similar to a manner in which a surety bond would. A surety bond or surety is a promise by a surety or guarantor to pay one party a certain amount if a second party fails to meet some obligation, such as fulfilling terms of a contract. The surety bond protects an obligee against losses resulting from a principal's failure to meet the obligation. As cryptocurrencies evolve from fringe investments to mainstream instruments, surety bonds may become an increasingly common requirement for those looking to trade in virtual currencies.

Ordinary surety bonds act as a contract between three parties: (i) an entity requesting the bond (principal), (ii) the bond's beneficiary (obligee), and (iii) a company issuing the bond. What a surety bond does is guarantee that the principal will fulfill its obligations, whether it's completing a long-term project or processing a financial transaction, or else forfeit the bond. Cryptocurrency surety bonds work in the same basic manner, ensuring that the principal performs cryptocurrency transactions as expected, or else forfeits the bond. In this case, the contract is between an entity handling a virtual currency transaction, a regulatory entity requiring the surety bond, and a surety bond provider.

In an example embodiment, a computational cryptographic system or digital key locker may be configured with a multiparty computation (MPC) security system to provide added security for digital assets (e.g., tokens such as NFTs). Such digital assets may be stored or hosted on blockchain(s), sidechain(s), or other suitable structure(s) known to those of skill in the art. The MPC security system may use a multiparty computation search element to implement robust fraud security. The MPC security system may provide multiple sharding to a cryptographic key, where the given key is used to secure a digital asset. In this way, multiple parties may be respectively assigned multiple key shards. The multiple key shards may control the digital asset. Cryptography may thus be implemented across the multiple key shards to realize a full key for securing the digital asset. The key shards may be stored in different ways to support different techniques for securing the digital asset, providing various security benefits of having multiple actors possess such shards.

In another example embodiment, the multiple shards may be accessible to a respective computing device or party upon submission or acceptance of a request for access to the shards. The MPC security system, or a platform upon which it is deployed, may delegate access to such devices/parties. Devices/parties acquiring access to shards may, for example, be players in an online gaming environment.

According to an example embodiment, the MPC security system may be configured to search transactions related to digital assets that occur on the platform, e.g., a blockchain platform, for indications of fraud, for instance, when an electronic wallet on the platform receives a transaction on a network, e.g., a public network. The MPC security system may pause a transaction related to a digital asset and interpret the transaction, looking for signatures from, for instance, three devices/actors associated with the transaction. The device(s)/actor(s) may include a representative of the electronic wallet, a user, and/or a compliance entity such as an electronic wallet operator. Each device/actor may possess its own key or key shard in association with the digital asset.

In another example embodiment, the MPC security system may add a layer of security to digital asset storage by enabling multiple shards to authorize cryptocurrency transactions. In an exemplary gaming environment, granting players access to portions of the shards to manage security and control of digital assets can improve security of digital assets during gameplay and enhance usability.

According to an example embodiment, by storing common digital assets in an electronic locker, the MPC security system can permit multiple devices (e.g., players) to access the common digital assets via a respective key shard associated with a respective device or player. In this way, access/control to common digital assets can be shared in a blockchain system and/or across multiple blockchain systems.

Further, in yet another example embodiment, the MPC security system can provide improved scalability, security, and control of digital assets in blockchain networks. Scalability may be improved by enabling a network to perform or process numerous transactions in a small amount of time, which may also be referred to as throughput. Digital asset transactions and computations via the MPC security system may achieve higher transaction throughput, similar to transaction processing speeds in centralized platforms. Security may be enhanced via use of multiple key shards to approve a transaction related to a digital asset.

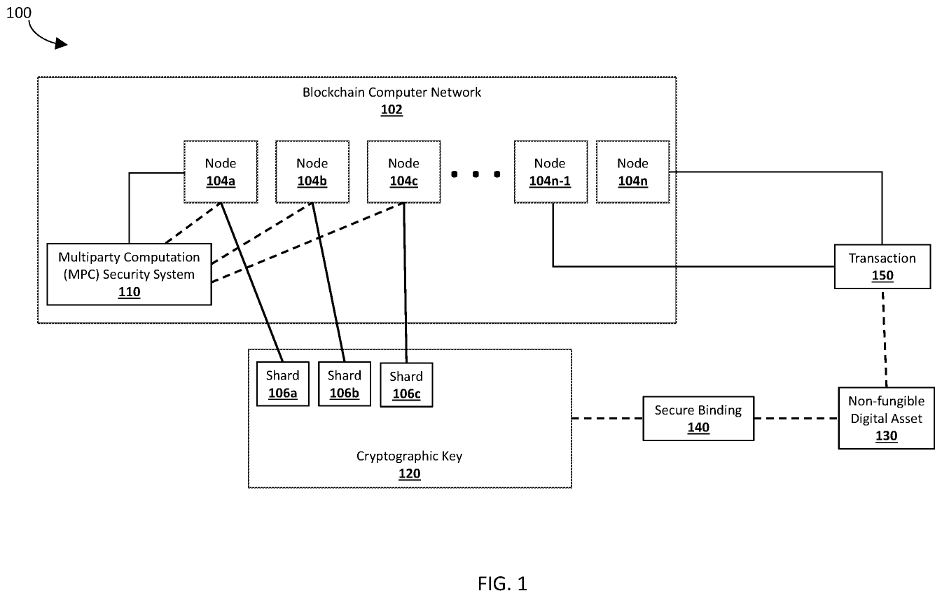

FIG. 1 is a block diagram of an example embodiment of a system 100 for securing a non-fungible digital asset. The system 100 includes a blockchain computer network 102 with multiple nodes 104a-n. A node, e.g., node 104a, may be configured to execute a MPC security system 110. The MPC security system 110 may be configured to implement a secure binding, e.g., secure binding 140, between a cryptographic key, e.g., cryptographic key 120, and a non-fungible digital asset, e.g., non-fungible digital asset 130. The MPC security system 110 may be further configured to computationally process shard(s) 106a-c of the cryptographic key 120 by assigning the shard(s) 106a-c to respective node(s) 104a-c of the multiple nodes 104a-n. The MPC security system 110 may be further configured to computationally pair the respective nodes 104a-c with the MPC security system 110. The MPC security system 110 may be further configured to verify secure possession of each shard of the shard(s) 106a-c by each corresponding node of the respective node(s) 104a-c. Responsive to the verifying, the MPC security system 110 may be further configured to approve or validate a transaction, e.g., transaction 150, for the non-fungible digital asset 130, which transaction 150 may occur among at least two, e.g., node 104n-1 and node 104n, of the multiple nodes 104a-n, thereby securing the non-fungible digital asset 130.

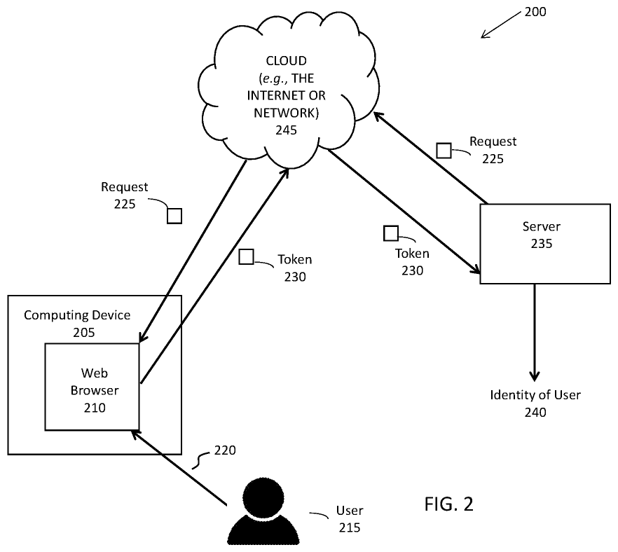

FIG. 2 shows an example of a user identification system 200 according to an embodiment. A user 215 interacts via user input 220 with a website displayed via a web browser 210 running on computing device 205, such as clicking an advertisement on the displayed website. The interaction is communicated to server (e.g., token server) 235. For example, a transparent pixel or script may be placed on the displayed website to communicate the interaction to the server 235.

An application executing on the server 235 determines whether the user 215 is a software robot or a person user by issuing a request 225 to web browser 210 to produce a token. The request 225 is sent over a network 245. In response to request 225, web browser 210 produces a token 230 on computing device 205. The token 230 is sent to the server 235 over network 245. The application executing on server 235 determines (e.g., using a computational challenge) a computational cost of producing the token 230. In some embodiments, the computational cost of producing the token 230 is based on the time taken to produce the token 230. Based on the computational cost of producing the token 230, the application on server 235 determines (deciphers) whether the user 215 is a software robot or a person user. In some embodiments, proving the computational cost of producing the token 230 at the computing device 205 is performed by an independent third party, rather than the application executing on server 235.

An application that determines whether the user 215 is software robot or a person user may also exist locally on the computing device 205. In this embodiment, it would not be necessary to send request 225 or token 230 over a network 245.

In some embodiments, the request 225 is issued in response to particular user engagement in the web browser 210 and based on user engagement metrics, including mouse movements by the user. The request 225 can also be issued in response to an elapsed period of time or issued by a web service.

In some embodiments, the application on server 235 of FIG. 2 calculates a confidence score and metrics associated with whether the user 215 operating computing device 205 is at least in part by a software robot or a person user. Once the application on server 235 determines whether user 215 is a software robot or a person user, the application on server 235 returns the identity of the user 240 and a calculated confidence score, which is associated with a likelihood of whether computing device 205 is being operated by a software robot or a person user. Thus, the calculated confidence score indicates a confidence value regarding the user identification. The confidence score helps the relying party determine a measure of confidence about the identity of the user 240.

The confidence score can be based on many different factors. One factor is the computational cost of the produced token 230. If the proven computation cost is low (below a threshold value), the confidence score may be increased. Further, if computing device 205 is a server, the computational cost is higher than if the computing device 205 is an individual machine, and thus the confidence score may be increased. The confidence score may be based on the time it took computing device 205 to produce the token 230. For example, longer times (e.g., above a time threshold) for producing token 230 may be associated with a higher likelihood that the identity of the user 240 is a software robot and a lower likelihood that the identity of the user 240 is a person user. In another embodiment, the confidence score is increased if the computing device 205 includes a Trusted Platform Module (TPM).

According to some embodiments, produced token 230 is captured in a cookie. In an embodiment, the captured produced token and the computational cost of the captured produced token 230 are time sensitive and expire after a period of time. Captured cookies can sign cookies generated in the future thus, building up proof of whether the web browser 210 running on computing device 205 is being operated by a person user or a bot. The building up of proof results in a longer block chain, making it increasingly difficult for a web browser running on a machine that is operated by a bot to continue to produce tokens.

In some embodiments, the confidence score may be calculated to further consider the confirmed purchase activities of the user. The score may increase when determined that a user is a verified purchaser who previously completed an online purchase. The proof of a user being an online purchaser, such as a retrieved proof of purchase cookie associating the user's identity to an entry in a database of confirmed purchases may increase the confidence score. For example, a retrieved proof of purchase cookie associating the user's identity particularly to a persistent entry in a block chain database of confirmed purchases may further increase the confidence score. That is, the trusted confirmation of the user as a verified purchaser may be associated with a higher likelihood (confidence) that the identity of the user is a person (rather than a software robot).

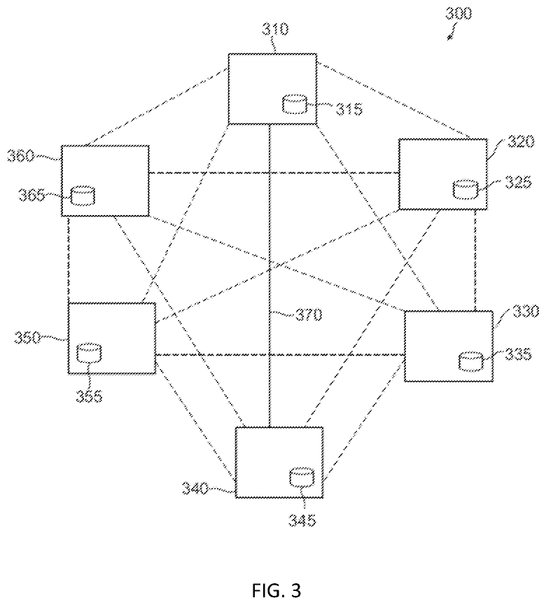

FIG. 3 is a block diagram of an example embodiment of a blockchain network 300, also referred to interchangeably herein as a distributed ledger network 300, that may be accessed according to an example embodiment. The blockchain network 300 is a distributed ledger P2P network and is valuable because this network enables trustworthy processing and recording of transactions without the need to fully trust any user (e.g., person, entity, program, and the like) involved in the transactions, reducing the need for trusted intermediaries to facilitate the transaction. Existing applications use the distributed ledger network 300 to transfer and record, in the form of blockchain based records, movement of tokens. Such blockchain based records form a cryptographically secured backlinked list of blocks.

The distributed ledger network 300 includes multiple computing devices configured as nodes 310, 320, 330, 340, 350, 360 of the distributed ledger network 300. Each node 310, 320, 330, 340, 350, 360 locally stores and maintains a respective identical copy 315, 325, 335, 345, 355, 365 of the blockchain ledger in memory communicatively coupled to the node. The nodes exchange messages within the distributed ledger network 300 to update and synchronize the ledger stored and maintained by each node. The nodes may also execute decentralized applications (dApps), such as via smart contracts, for processing the messages. A message transmission 370 from the node 310 to the node 340 may be used to exchange a token in the distributed ledger network 300 as shown in FIG. 3. The dotted lines between each set of nodes in the distributed ledger network 300 indicate similar transmissions that may be exchanged between any other set of nodes in the distributed ledger network 300. The messages may include a confirmed transfer for recording data associated with the token being transferred, such as a blockchain public key for each of the one or more parties participating in the transfer.

Continuing with FIG. 3, according to an example embodiment, the blockchain network 300 may be an Ethereum network; however, it should be understood that the blockchain network 300 may also be any suitable blockchain network known to those of skill in the art. Ethereum is a decentralized network of computers with two basic functions: (i) a blockchain that can record transactions and (ii) a virtual machine (VM), that is, an Ethereum Virtual Machine (EVM), that can produce smart contracts. Because of these two functions, Ethereum is able to support dApps. These dApps are built on the existing Ethereum blockchain, piggybacking off of its underlying technology. In return, Ethereum charges developers for the computing power in their network, which can only be paid in Ether (ETH), the only inter-platform currency. Depending on its purpose, a dApp may create ERC-20 (Ethereum Request for Comments issue number 20) tokens to function as a currency. According to an example embodiment, FTs disclosed herein may be ERC-20 tokens or any other suitable FT known in the art.

The code of the smart contract may be uploaded on the EVM, which may be a universal runtime compiler or browser, to execute the smart contract's code. Once the code is on the EVM, the code may be the same across each Ethereum node to be nm to check whether one or more condition(s) are met, such as a condition for secure possession of respective shard(s) of a cryptographic key by corresponding node(s) of a blockchain computer network.

Ethereum has a long history of developed standards. For example, ERC-20 is a standard that defines a set of six functions that other smart contracts within the Ethereum computer-implemented ecosystem can understand and recognize. ERC-20 is a protocol standard and in order to be ERC-20 compliant, the functions need to be included in the token's smart contract. ERC-20 outlines a specific list of rules that a given Ethereum-based token has to deploy, simplifying the process of programming the functions of tokens on Ethereum's blockchain. These include, for instance, how to transfer a token (by the owner or on behalf of the owner), such as may be employed for transferring FTs of a buyer, and how to access data (e.g., name, symbol, supply, and/or balance) concerning the token, such as a value of non-fungible digital asset 130 (FIG. 1).

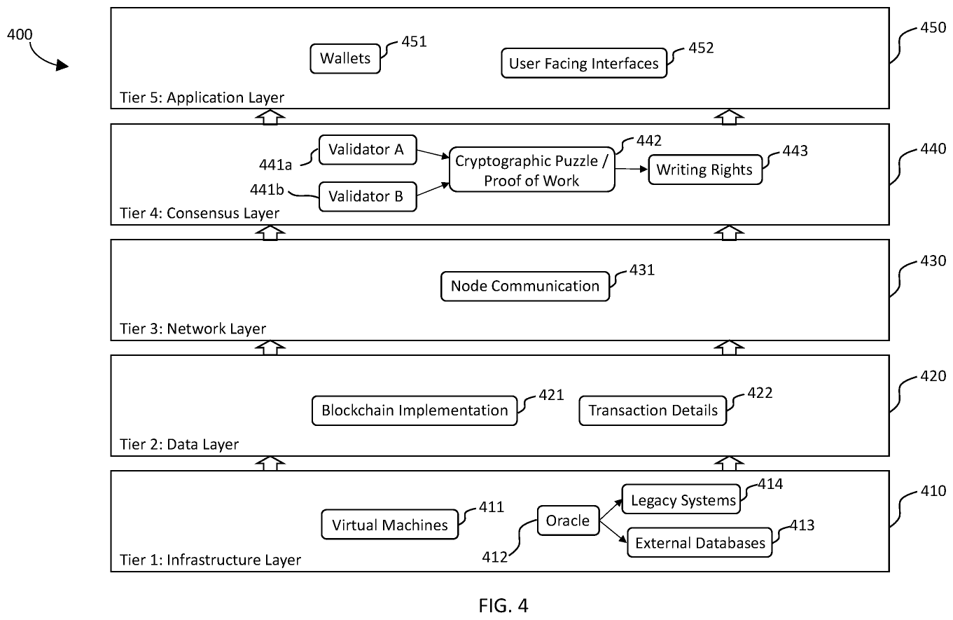

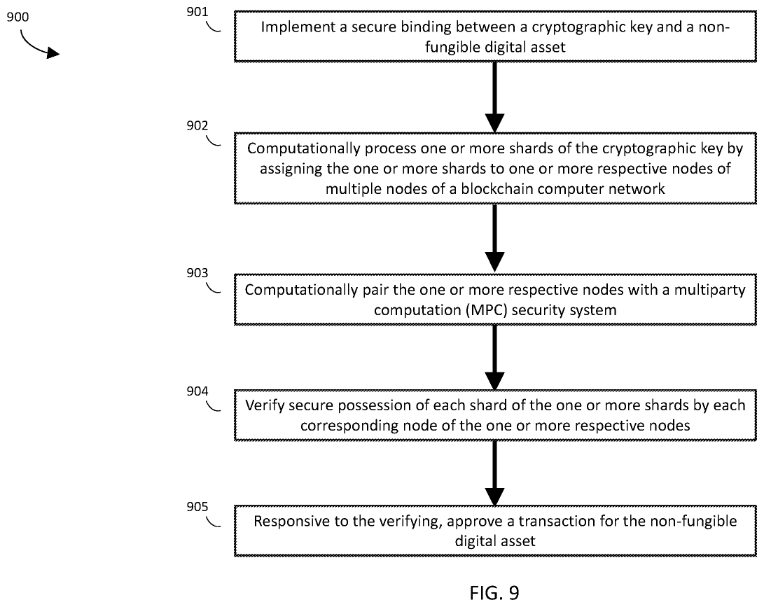

FIG. 4 is a block diagram showing exemplary blockchain layers 400 according to an embodiment. Blockchain layers 400 may include infrastructure (tier 1) layer 410, data (tier 2) layer 420, network (tier 3) layer 430, consensus (tier 4) layer 440, and application (tier 5) layer 450. The infrastructure layer 410 may be a hardware layer and may include one or more VM(s) 411 and/or one or more oracles 412. A VM 411 may provide a runtime environment for transaction execution in the blockchain. In an embodiment, a VM 411 may be, for example, stack-based and may enable untrusted code to be executed by a global P2P network of computers. An oracle 412 may provide a third-party service that connects smart contracts executing on the blockchain with off-chain data sources. For instance, an oracle 412 may query, verify, and/or authenticate one or more external data sources for the system 100 (FIG. 1) and/or a computer-based system/method 900 (described hereinbelow in relation to FIG. 9). According to an example embodiment, external data sources may include, e.g., one or more legacy systems 414 and/or databases 413.

According to an example embodiment, an oracle node architecture, e.g., oracle 412, may be provided to serve ML models for smart contracts on a blockchain. Example smart contract technology may be implemented by any suitable Web3 blockchain system known in the art, such as Ethereum, Cardano®, Solana, BNB (Build N′ Build) Smart Chain, Casper™, Kaleido, or Fantom.

The oracle architecture may be referred to as a “machine learning (ML) oracle.” The ML oracle is useful to smart contract developers who want to incorporate ML models into their smart contracts. For example, a smart contract may distribute funds based on an algorithm, and the algorithm may include a ML model that forecasts sales of a product for a given week. The smart contract may invoke an inference call to a model on the ML oracle to obtain the forecast. As a further example, there are generative arts where the generative ML model may be an integral part of an artwork. Interaction with the model to generate new images may be part of a viewing experience. One well-known ML model type used by generative art is a generative adversarial network (GAN). Using the ML oracle, the ML model may become part of an NFT, thereby enabling an interactive viewing experience.

To summarize, in an example embodiment, a smart contract may request an inference call to a ML model by identifying an ML model to call, such as by providing a hash value, and an input to the model. According to one such embodiment, a model file may be uploaded to, e.g., IPFS (InterPlanetary File System) or any other suitable known storage system, by a dApp developer and a model server may download the model file, e.g., using the hash value. For the ML model server to be generic enough to serve a wide range of models, it may also take as an input parameter a model type, e.g., PyTorch, TensorFlow, scikit-learn, or any other suitable known model type, as well as an input and output specification. The input may be data directly received from the calling smart contract, or it may be received indirectly via, e.g., an IPFS URI (Uniform Resource Identifier) or any other suitable identifier known to those of skill in the art. Similarly, the output may be sent back to the smart contract, or it may be uploaded to any suitable known storage system, including, but not limited to IPFS, and the, e.g., URI, may be sent to the smart contract. For instance, a forecasting model may use the direct input/output (I/O) method. An indirect I/O method employing a known storage system such as IPFS may be commonly used by computer vision/imaging models, among other examples.

In an example embodiment, the system 100 or the system/method 900 may include a VM, e.g., VM 411, with a blockchain oracle, e.g., oracle 412.

Continuing with FIG. 4, data layer 420 may interface with infrastructure layer 410 and may include blockchain implementation 421 and transaction details 422. A blockchain is a decentralized, massively replicated database (distributed ledger), where transactions are arranged in blocks, and placed in a P2P network. The blockchain implementation 421 may include a data structure represented, for example, as a linked list of blocks, where transactions are ordered. The blockchain implementation 421's data structure may include two primary components—pointers and a linked list. Pointers are variables that refer to a location of another variable, and a linked list is a list of chained blocks, where each block has data and pointers to the previous block. Each block may contain a list of transactions that happened since a prior block. Transaction details 422 may contain information about transactions occurring on the blockchain.

The network layer 430 may interface with data layer 420 and may also be referred to as a P2P layer or propagation layer. One purpose of network layer 430 may be to facilitate node communication 431, such that nodes can discover each other and can communicate, propagate, and synchronize with each other to maintain a valid current state of the blockchain. A distributed P2P network, e.g., network layer 430, may be a computer network in which nodes are distributed and share the workload of the network to achieve a common purpose. Nodes in network layer 430 may carry out the blockchain's transactions.

The consensus layer 440 may interface with network layer 430 and may ensure that blocks are ordered, validated, and guaranteed to be in the correct sequence. A set of agreements between nodes in a distributed P2P network may be established by the consensus layer 440. The agreements result in consensus protocols or algorithms, which correspond to rules that nodes follow in order to validate transactions and create blocks in accordance with those rules. To validate a transaction, a validator, e.g., validator 441a or validator 441b, may perform a consensus algorithm, such as proof of work 442 or any other suitable algorithm known in the art. Performing the consensus algorithm may involve expending computational resources to solve a cryptographic puzzle 442. After being validated according to a consensus algorithm, a transaction may be written to the blockchain through a process of writing rights 443.

The application layer 450 may interface with consensus layer 440 and may include customized applications and services, such as electronic wallets 451. Further, application layer 450 may include (not shown): smart contracts, chaincode, and/or dApps. The application layer 450 may also include applications utilized by end users to interact with the blockchain. Such applications may be, e.g., one or more user facing interfaces 452. Further, such applications may include, for example (not shown): scripts, application programming interfaces (APIs), and/or frameworks.

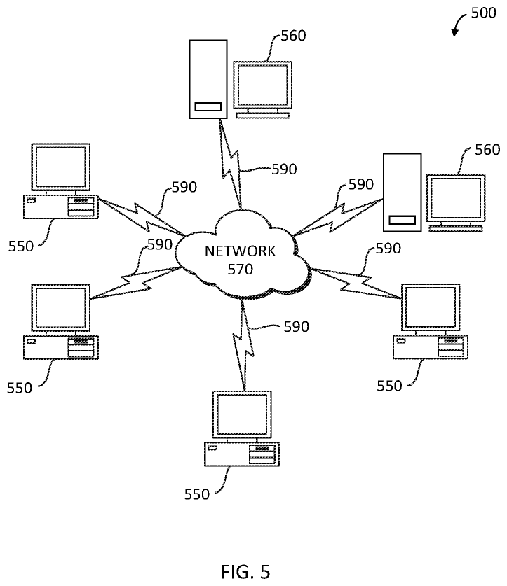

An example implementation of a MPC locker system to provide added security may be implemented in a software, firmware, and/or hardware environment. FIG. 5 illustrates one such example digital processing environment in which embodiments of the MPC locker system may be implemented. Client computer(s)/device(s) 550 and server computer(s)/device(s) 560 provide processing, storage, and I/O devices executing application programs and the like.

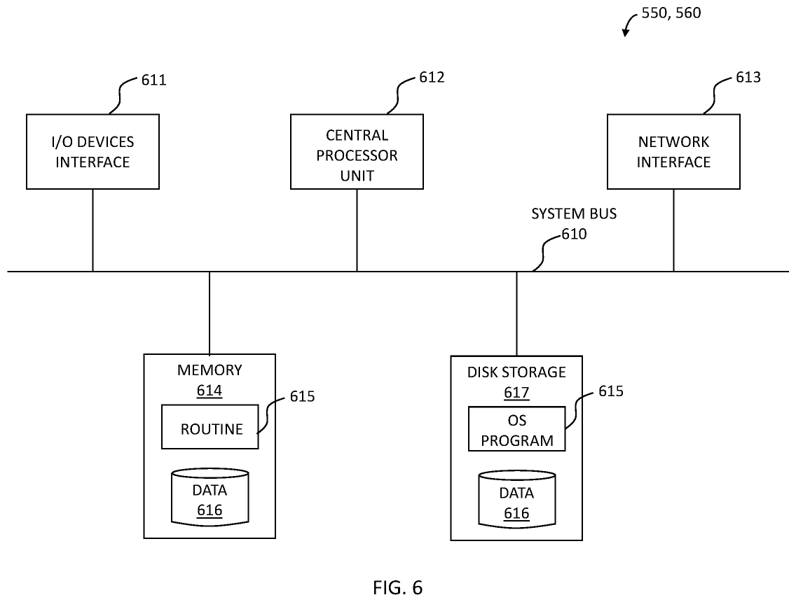

The client computer(s)/device(s) 550 may be linked 590 directly or through communications network 570 to other computing devices, including other client computer(s)/device(s) 550 and server computer(s)/device(s) 560. Referring to FIGS. 5 and 6 (the latter described in more detail hereinbelow), the network 570 utilizes a MPC locker system according to an example embodiment, for implementing a multiparty computation search system, which applies a mechanism of multiple sharding to a cryptographic key used to secure a digital asset, so that multiple parties may be respectively assigned multiple key shards. Cryptography is thus implemented across the multiple key shards to realize a full key for securing the digital asset.

The communication network 570 may be part of a wireless or wired network, a remote access network, a global network (e.g., the Internet), a worldwide collection of computers, local area networks (LANs) or wide area networks (WANs), and gateways, routers, and switches that may use a variety of known protocols (e.g., TCP/IP, Bluetooth®, etc.) to communicate with one another. Moreover, the communication network 570 may also be a virtual private network (VPN) or an out-of-band (OOB) network or both. In addition, the communication network 570 may take a variety of forms, including, but not limited to, a blockchain network, a distributed ledger network, a data network, voice network (e.g., landline, mobile, etc.), audio network, video network, satellite network, radio network, and pager network. Other known electronic device/computer network architectures are also suitable. For example, the client computer(s)/device(s) 550 may include the nodes shown in FIG. 3, which may run user applications that enable a user to communicate with an application to determine whether a user meets a work requirement. A blockchain network, such as blockchain computer network 102 (FIG. 1), may be configured on each user device 310, 320 (FIG. 3) to store tokens. The client computers 350 (FIG. 3) of the system 100 (FIG. 1) or the computer-based system/method 900 (FIG. 9) may be configured with a trusted execution environment (TEE) or TPM, where the application may be run and digital assets and/or tokens may be stored.

Referring again to FIG. 5, the server computer(s)/device(s) 560 of the system 100 or the computer-based system/method 900 may be configured to include a server that that executes an application. For example, the application of server computer(s)/device(s) 560 may be configured to provide a MPC locker system that verifies, records, and retrieves a cryptographic key, e.g., cryptographic key 120 (FIG. 1), used to secure a digital asset, e.g., non-fungible digital asset 130 (FIG. 1). The server computer(s)/device(s) 560 may not be separate server computers, but instead may be part of a cloud service. For another example, the server computer(s)/device(s) 560 or the client computer(s)/device(s) 550 may include the peer computing devices (nodes) 310, 320, 330, 340, 350, 360 of the distributed blockchain ledger 300 of FIG. 3, which use smart contracts to execute and record transactions implemented via tokens.

FIG. 6 is a block diagram of any internal structure of a computing/processing node (e.g., the client computer(s)/device(s) 550 or server computer(s)/device(s) 560) in the processing environment 500 of FIG. 5, which may be used to facilitate displaying audio, image, video, and/or data signal information. Each computer/device 550, 560 in FIG. 6 may contain a system bus 610, where a bus is a set of actual or virtual hardware lines used for data transfer among components of a computer or processing system. The system bus 610 may essentially be a shared conduit that connects different elements of a computer system (e.g., processor, disk storage, memory, I/O ports, etc.), thereby enabling transfer of data between elements or components.

Continuing with FIG. 6, attached to the system bus 610 is an I/O device interface 611 for connecting various input and output devices (e.g., keyboard, mouse, touch screen interface, displays, printers, speakers, audio inputs and outputs, video inputs and outputs, microphone jacks, etc.) to a computer/device 550, 560. A network interface 613 may allow a computer/device to connect to various other devices attached to a network, e.g., the network 570 of FIG. 5. A memory 614 may provide volatile storage for computer software instructions 615 and data 616 used in some embodiments to implement software modules/components of the system 100 (FIG. 1) or the system/method 900 (FIG. 9).

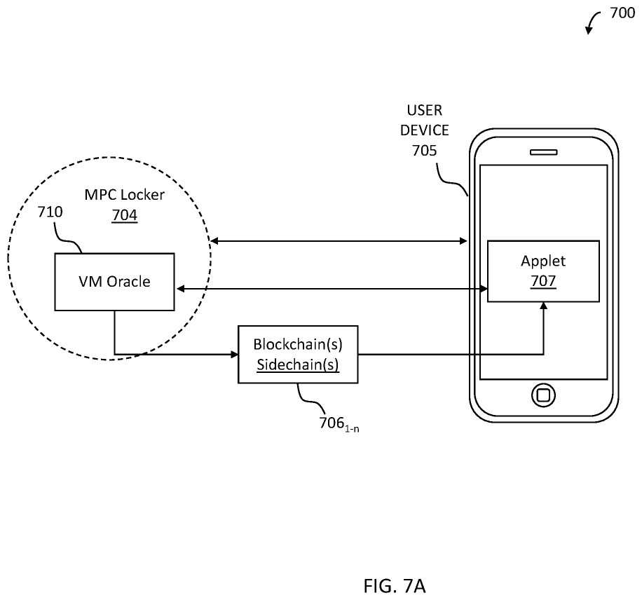

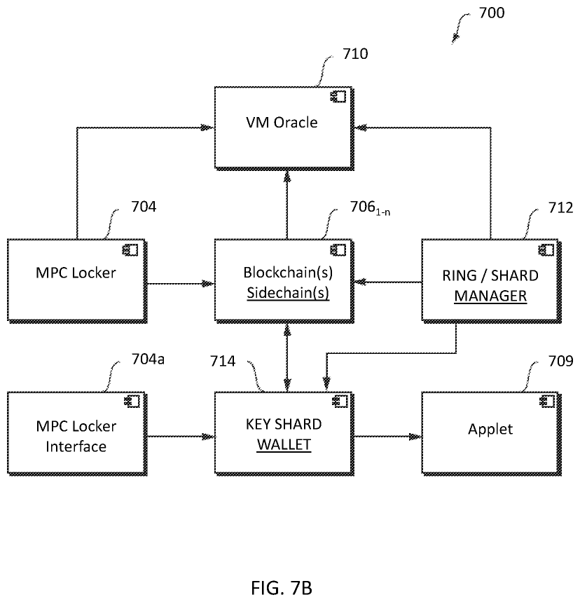

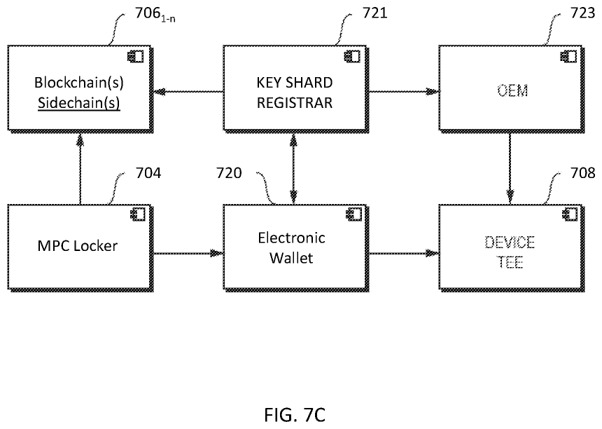

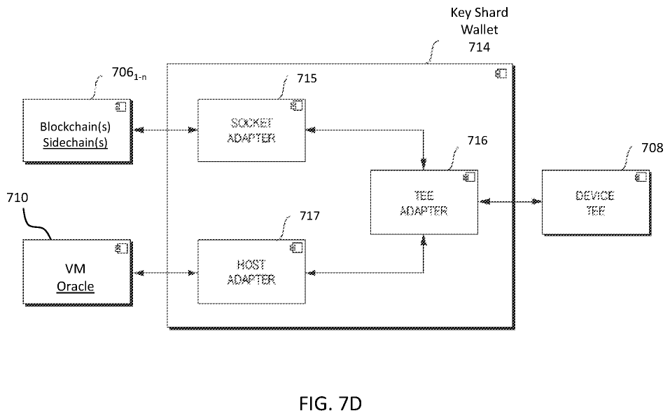

The software components 615, 616 of the system 100 or the system/method 900 (e.g., key shard integrity attestation and authentication software components, MPC search interface, MPC locker 704 (FIG. 7A), software components of the blockchain network 300 (FIG. 3), a minimax recursive algorithm, TPM/TEE, blockchain Layer 1 VM, encoder/decoder, oracle/ML oracle, wallet interface, applets, authentication site, cybersecurity controller, service applications, and the like) described herein may be configured using any suitable programming language known in the art, including any high-level, object-oriented programming (OOP) language, such as Python or Solidity. The computer-based system may include instances of processes that enable execution of transactions and recordation of such transactions. It should be understood that the terms “transaction” and “exchange” are herein used interchangeably, when used within a context of digitally transferring items of value, such as digital assets (e.g., non-fungible digital asset 130 (FIG. 1)), collateral assets, and/or collateral tokens, among entities associated with a blockchain network, e.g., the blockchain computer network 102 (FIG. 1) or the blockchain network 300 (FIG. 3). The system 100 or the system/method 900 may also include instances of a scoring engine and/or encoders/decoders, which can be implemented by, e.g., a server 560 and/or a client 550 that communicates with the server 560, using, for example, SSL (secure sockets layer), HTTPS (Hypertext Transfer Protocol Secure), or any other suitable protocol known in the art.

In an example mobile implementation, a mobile agent implementation of embodiments may be provided. A client-server environment may be used to enable mobile services using a network server, e.g., a server 560. It may use, for example, the Extensible Messaging and Presence Protocol (XMPP) protocol, or any other suitable protocol known to those of skill in the art, to tether a key shard device authentication engine/agent or wallet 615 on a user device 550 to a server 560. The server 560 can then issue commands to the user device 550 on request. The mobile user interface framework used to access certain components of the system 100 (FIG. 1) or the system/method 900 (FIG. 9) may be based on, e.g., XHP, Javalin, and/or WURFL (Wireless Universal Resource File), or other suitable known framework(s), interface(s), and/or combinations thereof. In another example mobile implementation for the iOS operating system (OS) and its corresponding API, the Cocoa Touch API may be used to implement the client-side components 615 using Objective-C or any other suitable known high-level OOP language that adds Smalltalk-style messaging to the C programming language.

A disk storage 617 may provide non-volatile storage for the computer software instructions 615 (equivalently “OS program”) and the data 616 may be used to implement embodiments of the system 100 or the system/method 900. The system may include disk storage accessible to a server computer 560. The server computer may maintain secure access to records associated with the system/method 900. CPU (central processing unit) 612 may also be attached to the system bus 610 and provide for execution of computer instructions. In one example embodiment, the CPU 612 is a secure cryptoprocessor implemented as a dedicated microprocessor configured to execute the composable asset control system. The cryptoprocessor may be specialized to execute cryptographic algorithms within hardware to support the composable asset control system. Functions include such things as accelerating encryption algorithms that verify compliance of encoded rules related to an NFT asset, enhanced tamper, and intrusion detection, enhanced data, key protection and security enhanced memory access and I/O to facilitate transactions across multiple blockchain systems.

In some embodiments, the processor routines 615 and the data 616 may be computer program products. For example, aspects of the system 100 or the system/method 900 may include both server-side and client-side components.

In other embodiments, authenticators/attesters may be contacted via, e.g., blockchain gaming systems, instant messaging applications, video conferencing systems, VoIP (voice over IP) systems, etc., all of which may be implemented, at least in part, in the software 615, 616. Further, in yet other embodiments, client-side components interfacing with the system 100 or the system/method 900 may be implemented as an API, executable software component, and/or integrated component of the OS configured to provide access to a key shard on a TPM executing on a client device 550.

In one embodiment, an example MPC locker system is implemented as an embedded VM, preferably executing on one or more cryptoprocessors configured to support efficient and scalable processing of application-to-blockchain and blockchain-to-blockchain transactions. The cryptoprocessor may be a dedicated computer-on-a-chip or microprocessor for carrying out cryptographic transaction operations, embedded in a hardware security module (HSM) with security measures providing failsafe tamper resistance. The embedded cryptographic processor can be configured to output decrypted data onto a bus in a secure environment, in that embedded cryptoprocessor does not output decrypted data or decrypted program instructions in an environment where security cannot be maintained. The embedded cryptoprocessor does not reveal keys or executable instructions on a bus, except in encrypted form, and zeros keys by attempts at probing or scanning

According to an example embodiment, the software implementations 615, 616 are computer program products, e.g., an application and smart contracts (generally referenced as 615), including a computer-readable medium capable of being stored on the storage device 617, which provides at least a portion of the software instructions for the system 100 or the computer-based system/method 900. Executing instances of respective software components of the system 100 or the system/method 900, such as instances of the application and/or smart contracts, may be implemented as computer program products 615, and may be installed by any suitable software installation procedure, as is well known in the art. In another embodiment, at least a portion of the system software instructions 615 may be downloaded over a wired and/or wireless connection via, for example, a browser SSL session or through an app (whether executed from a mobile or other computing device). In other embodiments, the system 100 or the system/method 900 software components 615 may be implemented as a computer program propagated signal product embodied on a propagated signal on a propagation medium (e.g., a radio wave, an infrared wave, a laser wave, a sound wave, or an electrical wave propagated over a global network such as the Internet, or other network(s) known in the art). Such carrier medium or signals may provide at least a portion of the software instructions for the system 100 or the computer-based system/method 900.

An example embodiment includes device code executed in a TEE or TPM. A TEE or TPM is a hardware environment that runs instructions and stores data outside a main OS of a device. This protects sensitive code and data from malware or snooping with purpose-built hardware governed by an ecosystem of endorsements, beginning with a device manufacturer. The system may perform checks on the TEE or TPM, such as executing BIOS (Basic I/O System) checks, to verify that folders (e.g., wallets) stored in the TEE/TPM have not been altered by malicious actors.

According to an example embodiment, the nature of a MPC locker system allows each actor to possess its own key, or key shard, in association with a digital asset. Therefore, each actor can maintain its cryptographic information in private while still allowing other actors on a network to gain access to the secured digital asset by requesting the key or key shard, without the need to provide underlying cryptographic information in the given key or key shard. In other words, in a multiparty computation search element configuration, each actor possessing an input to a function can see a result of the given function, without being able to see each respective actor's input to the given function. This allows multiple actors across the network to agree to provide access to a digital asset.

Further, in another example embodiment, MPC is a cryptographic tool that allows multiple parties to make calculations using their combined data, without revealing their individual input. MPC aims to ensure that participants in a network maintain their privacy in their individual information, while still being able to verify a variable relevant to multiple participants. Suppose participants A, B, and C contain respective numerical values X, Y, and Z; and the objective of the calculation is to determine the largest numerical value N of inputs X, Y, and Z. Each value X, Y, and Z would be entered into an example MPC tool, and each participant would only be made aware of the largest value, N and their own respective input.

In some embodiments, a MPC locker system may enable cross-chain transactions related to digital assets. Cross-chain transmission of NFTs and other digital assets between different blockchains may not be optimal. For example, such cross-chain processing can suffer from several issues, such as the lack of uniform enforcement of smart contracts (e.g., royalties) or carrying through metadata associated with an NFT, which would not typically be an issue within a single blockchain. According to an example embodiment of the MPC locker, a digital asset may be exchanged, cross-chain, securely. Such a digital asset may be in the form of a token, which may be fungible, or may be a NFT. Such constraints or rules may be in the form of smart contracts, or other forms.

According to an example embodiment, the MPC locker is configured to enable transfer of NFT digital assets across different blockchains. In one example, a NFT digital asset is configured with a specific owner. To enable transfer of the NFT digital asset from one blockchain to third party blockchain, the MPC locker is opened, and the NFT digital asset is deposited into the MPC locker with a signature and then locked. The ownership of the NFT digital asset is updated via an encoded smart contract, which is locked via digital signature. To unlock, the wallet is released and the NFT digital asset is pulled out.

In another example embodiment, unlocking is a two-step process where: (i) a signature is provided and (ii) permission to access is verified. The MPC locker is unlocked so the second participant with a separate address may access it. This may be performed with a protocol such as Spring or Cosmos® (via, e.g., sub-chains and/or the ABC [Asynchronous Blockchain without Consensus] protocol) or any other suitable known protocol; sub-chains may enable the transaction to be provable for determining which lockers are locked and which are unlocked. There is no server component. The application layer can trigger an action on one side of the MPC locker. In that use case, when the NFT digital asset is removed, it can be utilized in, for example, the respective game. The protocol is that when someone attempts to interact with the asset, there is a twin protocol that changes the others as well. This lock is on a smart contract level; the signature required is restricted via the MPC locker system.

In an example embodiment, a digital key locker is not on a sever. The digital locker may be implemented on a sidechain, blockchain, or in another distributed environment. The wallet address may receive information from locations on the chain. To enforce the locking on the chain without a server, a node is configured with an attested-to access level pass that enables through process via the access protocol. A custodial wallet may be implemented with a multiparty key. Another example embodiment may use zero-knowledge proofs (ZKPs) to perform the multiparty computation search, where there is only one key on the chain.

In an example embodiment, an oracle may be provided. The oracle may be configured based on rules and participate in the MPC locker system. The oracle would inherit the protocol, so the key signature design would be within that node. This may mean there is no trust, and the metadata may need to be verified as a rule set. The protocols may provide the message, a network bus and rules may be instituted, and information coming from each network may be enforced by the protocols.

FIG. 7A is a block diagram showing an example device authentication system 700 with components upon which an example MPC locker system may operate according to an embodiment. With these system components 700, network nodes can make use of hardened encryption and key shards in endpoint user device(s) 705 through an API 704a (FIG. 7B) to the MPC locker 704. The user device(s) 705 may provide processing, storage, and I/O devices executing application programs and the like. In addition, further services may be provided built on these system components 700 for device management, backup, attestation, etc. To support the system 100 or the computer-based system/method 900, registration of key shards and a set of device management services for attestation, backup, and device grouping, are managed. The system components 700, e.g., key shard wallet 714 (FIG. 7B), may also interface with an applet 709 (FIG. 7B).

It would be the intent of the system 700 not to maintain mission critical data as in conventional approaches, but rather to provide a platform for seamless, yet secure, connections between the MPC locker 704 and the user device(s) 705. On one end of the system is a VM oracle 710 that prepares an instruction for a user device 705 and at the other is the MPC locker system, which is applet 707 that can act on that instruction. A protocol may define how these instructions and replies are constructed.

According to an example embodiment, the system 700 may illustrate binding between a digital asset and multiple parties/devices. In another example embodiment, the system 700 may lock features of identity, transaction, and attestation based on the key shards of the respective user device(s) 705. Further, in yet another example embodiment, the system 700 may provide a ZKP attestation that a node implementing the MPC locker system minted a collateral token configured to consolidate liquidity within a blockchain protocol for an exchange of a digital asset. In this way, the attestation can improve processing time of a given exchange transaction by allowing the system 700 to approve an exchange if the exchange is performed on or facilitated by the node, thereby ensuring that the exchange is secure and that the MPC locker system provides liquidity to support the exchange of the digital asset.

In an example embodiment, the MPC locker system 700, shown in FIG. 7B, may use a secure socket, e.g., SSL or HTTPS, to maintain a persistent connection with devices. This channel may be used for pairing and other attestation functions of the MPC locker system. The VM oracle 710 may be provided to/utilized on blockchain networks for simplifying the encoding of a transaction. This VM oracle 710, for example, could be implemented in a programming language, such as a high-level, OOP language with dynamic semantics like Python.

A TEE may be implemented in a user device hardware security chip separate execution environment that runs alongside the rich OS and provides security services to that rich environment. The cryptographic keys and/or digital assets, collateral assets, or collateral tokens may be stored in the TEE. The TEE offers an execution space that provides a higher level of security than a rich OS. The TEE may be implemented as a VM, on the user devices, and/or on the network nodes.

A ring (shard) manager 712 can be implemented as a service provided to end-users for managing rings of shards (or clusters) to provide scalable execution and cross-chain deployment of MPC locker system(s) 704 across multiple blockchain systems. The MPC locker system(s) 704 may be grouped into a single identity and used to backup and endorse each other. Rings or shards may be associated with other rings to create a network of devices including any oracles. The rings may be a collection of individual device public keys (as opposed to a new key). If there are not many shared devices in the network, the list of devices may be short because of the potential for increased computational and bandwidth resources that may expended, and may introduce a time cost for encrypting a transaction, e.g., the transaction 150 (FIG. 1), with all of the key shards on a device list. According to an example embodiment, the ring/shard manager 712 may be configured to computationally pair one or more nodes (i.e., having one or more respective assigned shards) with a MPC security system, e.g., the system 100 (FIG. 1) or the computer-based system/method 900 (FIG. 9).

The MPC locker 704 will only unlock and allow access to the user device(s) 705 that contain, and provide, an appropriate key shard of the cryptographic key. The MPC locker system will then run a multiparty computational search algorithm with the provided cryptographic key to attest as to the validity of the provided key. If the MPC locker system determines that the provided key is valid, it will unlock the MPC locker 704 and allow the user device 705 access to the MPC locker 704. The user device(s) 705 present on blockchain(s)/sidechain(s) 706₁₋ₙ may form a ring, or cluster, which may each contain a shard of the cryptographic key, allowing each user device 705 access the MPC locker 704.

Ideally all instructions are signed by the MPC locker 704. This protects a cryptographic key shard from being applied by a rogue application. The VM oracle 710 is provided to help prepare and sign device instructions on the application server.

Key shard integrity attestation is provided by automating the assurance of the integrity of respective key shards against a known state such as a signatory on a blockchain transaction. The system 100 (FIG. 1) or the computer-based system/method 900 (FIG. 9) may include the several components shown in FIG. 7C. An electronic wallet 720 can be implemented as a software system running on an endpoint device that provides an interface to a MPC locker system 700 and integrates with the user device 705 TEE.

It should be noted that cryptocurrency wallets generally can also have known or unknown vulnerabilities. A side-channel attack, for example, is a potential vulnerability. In extreme cases, even a computer that is not connected to any network can be hacked. Modified versions of wallet apps used with emulators and simulators, or on device malware can be used by hackers to create fraudulent accounts, perform malicious transactions, or transfer cryptocurrency from one wallet app to another. Aspects of the MPC locker system provide improved security for digital assets.

In an example embodiment, a device TEE 708 is a software program that executes in a hardware secured TEE. The device TEE 708 is specially designed to execute cryptographic functions without compromise from malware or even the device operator. Another component, key shard registrar 721, is a service that registers a device into the blockchain(s)/sidechain(s) 706₁₋ₙ. The blockchain(s)/sidechain(s) 706₁₋ₙ may be used both to store device registration and attributes and to execute/encode transactions. There may be multiple distinct blockchains forming a ring, or cluster, which may all contain users with a cryptographic key shard allowing them to access the common MPC locker 704. Further, the MPC locker 704 provides robust fraud protection by only allowing access to the locker 704 by users possessing a valid cryptographic key shard. OEM (Original Equipment Manufacturer) 723 is the entity that built the user device and/or a Trusted Application Manager (TAM) authorized to cryptographically vouch for the provenance of the device.

In an example embodiment, when the electronic wallet 720 software shown in FIG. 7C runs for the first time to process an NFT, it will ask the device TEE 708 to generate multiple shards of a cryptographic key and allocate respective instances of them to users/devices. Cryptography is implemented among the multiple key shards to realize a full cryptographic key. Each cryptographic key shard may be signed. This signed cryptographic key shard may be sent to the key shard registrar 721 and validated if there is a transaction related to the NFT. Registration may involve confirmation from the device operator. The registrar may ask additional details about the respective devices to further verify identify, such as BIOS version, OS version, and/or GPS (Global Positioning System) location, etc. This data may be signed by the fully realized cryptographic key. It may be further signed by the registrar. The resulting data set may become the gold reference or reference value for future key shard integrity checks. Confirmation from the device operator may be required in collecting the gold reference or reference value.

The blockchain(s)/sidechain(s) 706₁₋ₙ. may be a JSON (JavaScript Object Notation) API written in Python, which uses the third-party agent/process private key to enroll the key shards of devices 705 and the MPC locker system 700. During enrollment, the public key of the user device 705 or the MPC locker system 700 is recorded by the TEE applet 708. Enrollment enables the TEE applet 708 to pair a device 705 with the MPC locker 704. In an example embodiment, the other devices having key shards would be paired with the MPC locker system 700 for transactions (e.g., access, transfer) related to the subject electronic asset to be approved.

A key shard protocol specifies the structure of an instruction and the signing/encryption that must be applied for the device 705 to accept the instruction. The instruction itself may, for instance, be prepared as a C structure that contains the instruction code, version data, and payload. The entire structure may be signed by the MPC locker cryptographic key if all of the key shards are approved and delivered to the device TEE applet 708 by calling a device local command

Every user device 705 should present unique identity credentials and their respective key shard. Devices having respective key shards may join a ring, or cluster, so as to act as a singular entity to control the electronic asset (e.g., NFT). For example, a user device 705 can support group identifiers (IDs) that are locally stored as a list, but publicly translate into cross-platform authentication. TEE adapter 716 (FIG. 7D) may be configured as the interface between the MPC locker system 700/TEE applet 708 bolted into the TEE and the outside world of partner apps and online services. In an implementation, it can manifest in one or more diverse forms, which would be at least partially dictated by the basic capabilities across devices, hardware support, and OS architecture.

In an example embodiment, the key shard wallet 714 may include outward and inward-looking interfaces as shown in FIG. 7D. The inward-looking interface, the TEE adapter 716, handles proprietary communications with the MPC locker system 700. A host adapter 717 is provided to expose services to third-party applications. The host adapter 717 may present the interface of the key shard wallet 714 through different local contexts, such as browsers or system services. Multiple realizations for diverse contexts are envisioned. A socket adapter 715 may connect the client environment blockchain(s)/sidechain(s) 706₁₋ₙ. The TEE adapter 716 may be the glue that pipes commands into the MPC locker system 700. The key shard wallet 714 can interface with the TEE adapter 716 and transmit message buffers that are piped to the MPC locker system 700, and then synchronously await notification of a response event related to the electronic asset. The host adapter 717 may isolate the TEE adapter 716 from the host environment. The host adapter 717, in an example embodiment, could operate in a potentially hostile environment. The host adapter 717's role may be to facilitate easy access to the MPC locker system 700. Instructions from a MPC locker 704 intended for the MPC locker system 700 may be signed by the MPC locker 704 and then passed through to the TEE adapter 716 and the MPC locker system 700.

The plurality of devices having shards of the cryptographic key may be registered with the MPC locker. The blockchain(s)/sidechain(s) 706₁₋ₙ may have a special capability of pairing additional MPC lockers with that device 705. Communications with the first blockchain(s)/sidechain(s) 706₁₋ₙ may be handled through the web API and preferably are authenticated. In an example embodiment, this may be implemented with an API key. This may be implemented using an SSL key swap. In some embodiments, all requests are signed.

The MPC locker system 700 provides robust security through the multiparty computation search algorithm. This should make it more difficult for an attacker to access a digital asset in the MPC locker, because, if the attacker does not possess a valid key shard, access to the MPC locker will not be validated. Furthermore, the system 700 may be preferably in near constant contact with all the devices 705 through the socket adapter 715 shown in FIG. 7D.

In an example embodiment, the blockchain(s)/sidechain(s) 706₁₋ₙ may include several subcomponents. For instance, each block on the blockchain(s)/sidechain(s) 706₁₋ₙ may contain hashes, a height, a nonce value, confirmations, and/or a Merkle Root, among other examples.

In another example embodiment, the MPC locker system 700 may be configured to interface with the VM oracle 710. According to an example embodiment, the MPC search component may interface with or be coupled with the VM oracle 710. A request to access a subject NFT may trigger a key shard command to be executed by associated device(s). The command may be signed and/or encrypted by the MPC locker system 700. The cryptographic key shards from the respective devices are preloaded into the MPC locker system during a pairing process, which may be conducted by the blockchain(s)/sidechain(s) 706₁₋ₙ. This allows the MPC locker system 700 to validate the origin of the request, and, if needed, decrypt the contents of the instruction, and request that the other devices having key shards approve it. A quorum of key shards or all the key shards may be needed to execute a transaction related to the electronic asset (e.g., NFT).

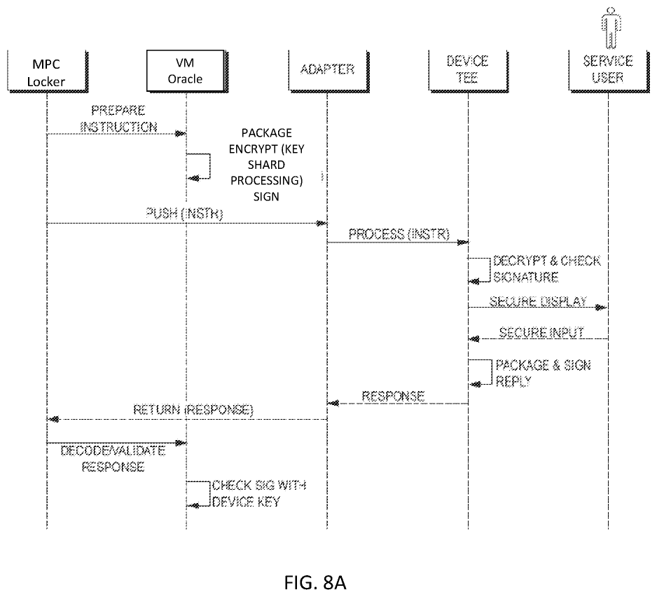

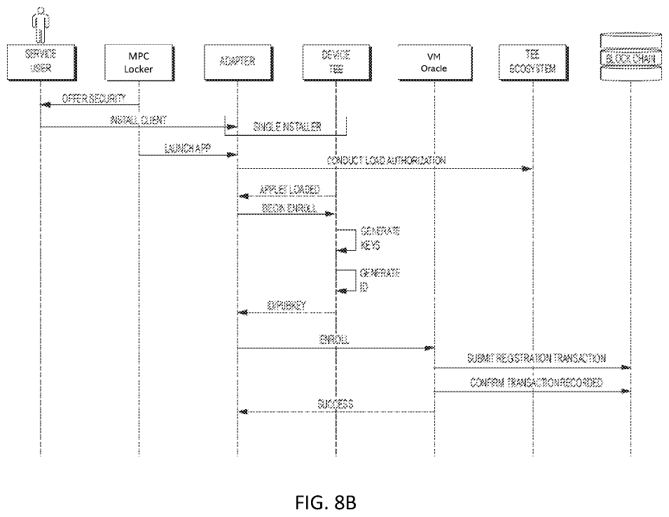

In an example embodiment, a sequence of packaging and delivering an instruction is shown in FIG. 8A. The MPC locker 704 generates an instruction record with the help of the VM oracle 710 libraries. The instruction may include a type, a target device, and/or payload. The instruction may be encoded with the cryptographic key shard and must be signed by the MPC locker realized key. The cryptographic key is fetched from the blockchain(s)/sidechain(s) 706₁₋ₙ by looking up the device registration record.

In another example embodiment, device enrollment or creation of a key shard stored in a TEE of a device may be performed. The example enrollment process, shown in FIG. 8B, should be hassle free, or even transparent to the user. This example embodiment may ensure that the key shard processed via the MPC search locker system is operating in a proper TEE.

In an embodiment of FIG. 7C, when the electronic wallet 720 software runs for the first time, it will ask the device TEE 708 to generate a cryptographic key shard. The key shard is signed by the realized key established during the cryptographic key's creation and a hash of it may be registered by the key shard registrar 721. The key shard registrar 721 may also obtain additional information to verify the device, such as one or more of the following: a composite value of the Platform Configuration Registers (PCRs) generated by the boot process, BIOS version, OS version, GPS location, BIOS identifier, a network interface identifier, attributes about the device, such as number of files, size of files, directories, indexes, and data/search tree structures, processor identifying number of the device, or other such information. This data is signed by the device private key and may be further signed by the key shard registrar 721. The key shard registrar 721, or another trusted key shard verification integrity server, creates a blockchain account key (a public/private key pair) that can be referenced as a signatory in a MPC locker transaction on the blockchain.

FIG. 9 is a flow diagram of an exemplary computer-based system/method 900 for securing a non-fungible digital asset according to an embodiment. The system/method 900 begins by implementing 901 a secure binding, e.g., secure binding 140 (FIG. 1), between a cryptographic key, e.g., cryptographic key 120 (FIG. 1), and a non-fungible digital asset, e.g., non-fungible digital asset 130 (FIG. 1). The system/method 900 continues by computationally processing 902 shard(s), e.g., shard(s) 106ₐ₋ₙ (FIG. 1), of the cryptographic key by assigning the shard(s) to respective node(s) of multiple nodes, e.g., nodes 104ₐ₋ₙ (FIG. 1), of a blockchain computer network, e.g., blockchain computer network 102 (FIG. 1). In turn, the system/method 900 computationally pairs 903 the respective node(s) with a MPC security system, e.g., MPC security system 110 (FIG. 1). The system/method 900 then verifies 904 secure possession of each shard of the shard(s) by each corresponding node of the respective node(s). Responsive to the verifying 904, the system/method 900 approves 905 a transaction, e.g., transaction 150 (FIG. 1), for the non-fungible digital asset. The transaction may occur among at least two of the multiple nodes. Approving 905 the transaction responsive to the verifying 904 may thereby secure the non-fungible digital asset.

As a further example embodiment for payment processing transactions related to the NFT, the MPC locker system may interface with a VM/oracle for (i) assessing fraud risk; (ii) maximizing approval rate based on the NFT asset; (iii) identifying digital property rights; and/or (iv) managing IDs. In an example embodiment, this processing may result in reduced fraud and improved processing (transaction approval) time.

An example embodiment includes a hierarchical digital wallet stored off-chain, which may include a key locker built on top of a multiparty computation search element via multiple sharding. The MPC locker system may search for fraud for payment by identifying a transaction on a public network, temporarily stopping the transaction, and interpreting it. The MPC locker system may look for three actors: (i) the wallet itself; (ii) the user; and (iii) the wallet operator. Each of these three actors may have their own locker.

An example embodiment for interchain asset management includes the method of bridging, i.e., moving one asset from one network to another network. Each wallet may be paired with digital assets on more than one network, and each asset may contain protocol designs with rules and metadata that can track on multiple networks.

An example embodiment for bridging the wallet includes the steps of (i) depositing the digital asset; (ii) one digital asset represents the metadata for moving an NFT to the locker; and (iii) burning the asset, i.e., sending the asset to a location on the network which does not exist.

In an example embodiment, the locker is capable of transferring NFTs. According to another example embodiment, the NFT may have respective owner(s), metadata, a compatibility layer, and/or specific flags. A locker is opened, and a digital asset is deposited with a signature and locked. The owner is now the contract, which will be unlocked by a signature. To unlock, the wallet is released and the NFT is pulled out. In another example embodiment, unlocking is a two-step process where (i) a signature is provided and (ii) permission to access is verified. The locker is unlocked so the second participant with a separate address may access it. This may be performed with a protocol such as Spring or Cosmos (via, e.g., sub-chains and/or the ABC protocol), or any other suitable known protocol; sub-chains may enable the transaction to be provable for determining which lockers are locked and which are unlocked. There is no server component. The application layer can trigger an action on one side of the locker. In that use case, when the NFT is removed, it can be utilized in the respective game. The protocol is that when someone attempts to interact with the asset, there is a twin protocol so that the other changes as well. This lock is on a smart contract level; the signature required is restricted via MPC.

In an example embodiment, the locker is not on a sever. The wallet address may receive information from locations on the chain. To enforce the locking on the chain without a server, a business locates a level, then a pass through to get through that protocol. There is a custodial wallet with a multiparty key. Another example embodiment may use ZKPs to perform the multiparty computation, where there is only one key on the chain.

In an example embodiment, an oracle may be required to know the rules and participate in the multicount protocol. The oracle would inherit the protocol, so the key signature design would be within that node. This may mean there is no trust, and the metadata may need to be verified as a rule set.

In another example embodiment, protocols may provide a message, a network bus and rules may be instituted, and information coming from each network may be enforced by the protocols.

A further example embodiment for payment processing may perform steps of (i) assessing fraud risk; (ii) maximizing approval rate based on an asset being purchased; (iii) identifying digital property rights; and/or (iv) managing IDs. This may result in a reduced processing time.

A composable digital asset integrates two or more individual digital assets into a new combined form, which may be referred to as an asset cluster. An asset cluster may comprise components of similar or different types. For example, an asset cluster may include an element of fungible currency such as cryptocurrency, along with a NFT. Thus, combining an amount of cryptocurrency with an NFT effectively establishes a floor value for the NFT equal to the value of the fungible cryptocurrency.

Such composable assets may find applications in areas such as finance and gaming. An example embodiment of a gaming application of composable digital assets involves a piece of armor having a socket, into which a gem may be placed, creating an asset cluster. Asset clusters may be decomposed at any time such that the NFT and the currency item again become separate entities on a digital exchange platform.

Composable digital assets can provide liquidity for any digital asset or token. For example, a player of a game incorporating composable digital asset clusters may use a currency component of a cluster to set an instantaneous value at which to sell the cluster, such as to an automated market maker (AMM) associated with the game. Composable assets may be referenced or required by contracts or rules governing transactions on a digital exchange platform, such as smart contracts.

An AMM cryptographic system may be configured to provide liquidity to a platform enabling exchange of digital assets as described herein. The exchange platform may be decentralized. Liquidity may be provided using underlying collateral. The AMM cryptographic system may take in and store different forms of digital assets, such as loans, to be used as collateral in future exchanges on the platform. Such assets may be aggregated within a collateral pool, such that liquidity is pooled in association with the exchange platform. Liquidity may thus be pooled and aggregated on a blockchain supporting the collateral pool. Assets may be withdrawn from the collateral pool upon minting a collateral token. The collateral token may thus consolidate liquidity for an exchange within one protocol or contract. In addition, the collateral token may provide liquidity for a one-to-one exchange with a user looking to sell or redeem a user-held token.

In an example embodiment, a clearinghouse program implemented upon the platform may be configured to force an exchange to be performed on the platform such that the exchange is managed by the AMM cryptographic system. A machine learning oracle of the AMM cryptographic system may set a computational value for a collateral token, and may offer the collateral token for exchange at such a computational value, thus quantifying the market value for that token, rather than deferring to market forces. The AMM cryptographic system may function with either a bounded or unbounded token supply, providing continuous liquidity. The AMM cryptographic system may be configured to measure supply and demand for tokens on the platform, including the collateral tokens. The AMM cryptographic system may be configured with an encoder/decoder. The AMM cryptographic system encoder may be configured to mint and/or encode collateral tokens.

The AMM cryptographic system may be implemented by any suitable protocol known to those of skill in the art, such as ERC-20, among other examples.

A digital asset marketplace may leverage a clearinghouse to enforce a contract governing transfer of tokens between electronic wallets. The contract may specify royalties to be paid to an original creator of a token upon transactions involving that token. In addition, the contract may include a revenue share table. The clearinghouse may be configured to enforce the contract regardless of network locations of two parties involved in a transaction, and regardless of whether or not the transaction is conducted within the digital asset marketplace. For example, even offline exchanges may be made transparently viewable from within the digital asset marketplace. The clearinghouse may be configured to serve any token creator. In addition, the clearinghouse may include a minimax recursive algorithm to facilitate a threshold value associated with the token.

In an example embodiment, upon creation of a token, a threshold value of that token may be set within the digital asset marketplace. The clearinghouse may implement rules in conjunction with the threshold value to prevent the value of the token from experiencing dramatic changes characteristic of backdoor or offline transactions. As such, the threshold value may act as a floor price of the token required to activate any transaction involving the token. The clearinghouse may manage and approve or deny transactions accordingly. Rules such as threshold values may be based on a bounded percentage of a price change from a previous transaction. Such a clearinghouse can be implemented in a decentralized manner, such as with a smart contract. A central authority may thus not be required.

Certain embodiments may offer techniques for verifying or checking an identity that protect, preserve, and maintain privacy. Safeguarding privacy within blockchain networks is an important consideration for traditional institutions such as banks and other financial institutions that may desire to interact with and/or launch smart contracts, for example, as part of digital asset transactions, but may also need to keep trade secrets and/or sensitive customer information etc. confidential. As to the latter, such institutions may also be required to comply with rules and/or regulations including, but not limited to, the Europe Union's General Data Protection Regulation (GDPR) and the United States' Health Insurance Portability and Accountability Act (HIPAA), among other examples.

In an example embodiment, the MPC locker system may be accomplished by use of, e.g., a ZKP. A zero-knowledge proof implementation in the MPC locker system ensures enforcement of encoded rules configured in NFT assets utilizing a technique whereby a first entity (or “prover”), such as first transacting entity, a first wallet etc., may cryptographically prove to a second transacting entity (or “verifier”) that the first entity possesses knowledge regarding certain information regarding the encoded rules in configured in the NFT, without also disclosing the actual contents of the information.

ZKPs may be interactive or non-interactive. An interactive ZKP requires interaction between a prover entity and a verifier entity involved in an NFT encoded rule enforcement transaction processed by the MPC locker system. A non-interactive ZKP may be constructed from any interactive scheme by relying on, e.g., a Fiat-Shamir heuristic, or any other suitable technique known to those of skill in the art.

According to an example embodiment, a protocol implementing ZKPs may be presented as a transcript where a prover (first entity) responds to interactive inputs from a verifier (second entity). In another example embodiment, the interactive input may be in the form of one or more challenges such that responses from the prover will convince the verifier if and only if a statement is true, e.g., if the prover does possess certain asserted knowledge.

In the context of blockchain networks, according to some embodiments, by employing a ZKP, the only information divulged on-chain is that some piece of undisclosed information is (i) valid and (ii) known by the prover with a high degree of certainty. As such, in an example embodiment, ZKPs may be used by various blockchains to furnish privacy-maintaining digital asset transactions, whereby, for example, a transaction's amount, sender electronic wallet identifier, and receiver electronic wallet identifier are kept secret. Furthermore, some embodiments relate to oracle networks that provide smart contracts with access to off-chain data and/or computing infrastructure. Such oracle networks may also employ ZKPs to prove a certain fact about off-chain data, without divulging the data itself on-chain. A method used for performing non-interactive ZKPs may be as described in D. Unruh, “Non-Interactive Zero Knowledge Proofs in the Random Oracle Model,” in EUROCRYPT 2015, 2015, pp. 755-84, which is herein incorporated by reference in its entirety.

Further, a method for creating and executing ZKP applications in embedded systems may be as described in Salleras, et al., “ZPiE: Zero-Knowledge Proofs in Embedded Systems,” Mathematics, vol. 9, no. 20, p. 2569, 2021, which is herein incorporated by reference in its entirety.

A digital wallet, such as a hybrid multisignature digital wallet, may be provided to enable a licensed custodian or designee to provide signatures or keys required to approve a digital transaction. The custodian may approve transfers of tokens on digital exchange platforms such as blockchain platforms. A set of custodian signatures, potentially from multiple custodians, may be required to approve a transaction. Alternatively, the hybrid multisignature digital wallet may be configured in a one-of-many or a one-of-one setup, requiring only a single signature of one or more valid signatures from one or more custodians to approve the transaction. If a network allows a designated party to be a custodian, that party may enter into an agreement at the protocol level on the network to become a designated custodian. The hybrid multisignature digital wallet may be implemented in support of compliance operations. The custodian may facilitate recovery or replacement of lost signatures or keys, or of entire lost wallets.

The hybrid multisignature digital wallet may enable transactions such as token swaps, and may facilitate transfer of tokens across multiple networks. Individual networks of the multiple networks may implement rigorous or lenient constraints upon transactions performed within the respective networks. Thus, a disparity may exist between two networks involved in a token transfer. The custodian may facilitate management of such a disparity. The custodian may perform functions characteristic of an automated escrow service in conjunction with a digital exchange platform.

An example embodiment includes a hierarchical digital wallet stored off-chain, which include a key locker built on top of a multiparty computation search element, i.e., the MPC locker system, via multiple sharding. The MPC locker system may search for fraud for payment by identifying a transaction on a public network, temporarily stopping the transaction and interpreting it. The MPC locker system may be configured to identify and interface with at least three actors: (i) the wallet itself; (ii) the user device; and (iii) the wallet operator.

In an example embodiment, a system may be provided for bridging an electronic wallet to enable NFTs to be transferred from one blockchain to another (e.g., from a first blockchain system to a second blockchain system). The process for bridging the wallet may include: (i) depositing the NFT digital asset in a locker; (ii) configuring one portion of the NFT digital asset to update the metadata to specify that that the NFT digital asset is moved to the locker; and (iii) burning the NFT digital asset on the first blockchain, e.g., configuring the NFT digital asset on the first blockchain so that it is ownership identification is on an address location which does not exist.

In another example embodiment, once the NFT digital asset is burned, it is destroyed on the first blockchain. The process may involve assigning ownership of the NFT digital asset to an un-spendable address that no one has access to. For example, an eater address or a null address. The NFT digital assets sent to a null address are considered unusable because the transaction is irreversible. According to an example embodiment, once the NFT digital asset is burned on that blockchain, it cannot be recovered.

Further example embodiments disclosed herein may be configured using a computer program product; for example, controls may be programmed in software for implementing example embodiments. Further example embodiments may include a non-transitory computer-readable medium containing instructions that may be executed by a processor which, when loaded and executed, cause the processor to complete methods described herein. It should be understood that elements of the block and flow diagrams may be implemented in software or hardware, such as via one or more arrangements of circuitry of FIG. 6, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer-readable medium, such as random-access memory (RAM), read-only memory (ROM), compact disk read-only memory (CD-ROM), and so forth. In operation, a general-purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

It should be understood that the term “blockchain” as used herein includes all forms of electronic, computer-based distributed ledgers. These include consensus-based blockchain and transaction-chain technologies, permissioned and un-permissioned ledgers, shared ledgers and variations thereof. While Bitcoin and Ethereum may be referred to herein for the purpose of convenience and illustration, it should be noted that the disclosure is not limited to use with the Bitcoin or Ethereum blockchains and alternative blockchain implementations and protocols fall within the scope of the present disclosure.

It should also be noted that not all currently known distributed ledger systems utilize linear blockchains as such. Some known blockchain implementations utilize lattice or mesh data structure(s), and some utilize directed acyclic graphs (DAGs).

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-based system for securing a non-fungible digital asset, the computer-based system comprising:
a blockchain computer network including multiple nodes,
at least one of the multiple nodes configured to execute a multiparty computation (MPC) security system,
the multiparty computation (MPC) security system configured to:
implement a secure binding between a cryptographic key and a non-fungible digital asset;
computationally process one or more shards of the cryptographic key by assigning the one or more shards to one or more respective nodes of the multiple nodes;
computationally pair the one or more respective nodes with the multiparty computation (MPC) security system;
verify secure possession of each shard of the one or more shards by each corresponding node of the one or more respective nodes; and
responsive to the verifying, approve a transaction for the non-fungible digital asset, the transaction occurring among at least two of the multiple nodes, thereby securing the non-fungible digital asset.

2. The computer-based system of claim 1, wherein the non-fungible digital asset is a non-fungible token (NFT).

3. The computer-based system of claim 1, wherein the multiple nodes are configured to operate in connection with each other in the blockchain computer network.

4. The computer-based system of claim 3, further comprising at least one additional blockchain computer network, wherein the transaction is configured to perform a cross-chain transfer of the non-fungible digital asset between the blockchain computer network and the at least one additional blockchain computer network.

5. The computer-based system of claim 1, wherein a first node of the multiple nodes is configured to request access to a shard of the one or more shards, and wherein a second node of the multiple nodes is configured to delegate access to the shard to the first node.

6. The computer-based system of claim 5, wherein the second node is configured to manage access to the shard to which the first node is configured to request access.

7. The computer-based system of claim 5, wherein the first node is a client device configured to interface with an online gaming environment.

8. The computer-based system of claim 1, wherein the transaction is a first transaction, and wherein the multiparty computation (MPC) security system is further configured to detect at least one indication of fraud in a second transaction for the non-fungible digital asset.

9. The computer-based system of claim 8, wherein the multiparty computation (MPC) security system, upon detecting the at least one indication of fraud, is further configured to:
preempt the second transaction; and
verify the cryptographic key securely bound with the non-fungible digital asset, wherein the one or more shards include at least three shards associated with at least three respective nodes of the multiple nodes.

10. The computer-based system of claim 9, wherein the at least three respective nodes include at least one of: a wallet node, a user node, and a compliance node.

11. The computer-based system of claim 1, wherein:
the at least one of the multiple nodes includes a secure cryptoprocessor implemented as a dedicated microprocessor configured to execute the multiparty computation (MPC) security system; and
the multiparty computation (MPC) security system is embedded on the secure cryptoprocessor.

12. A computer-implemented method of securing a non-fungible digital asset, the computer-implemented method comprising:
implementing a secure binding between a cryptographic key and a non-fungible digital asset;
computationally processing one or more shards of the cryptographic key by assigning the one or more shards to one or more respective nodes of multiple nodes of a blockchain computer network;
computationally pairing the one or more respective nodes with a multiparty computation (MPC) security system;
verifying secure possession of each shard of the one or more shards by each corresponding node of the one or more respective nodes; and
responsive to the verifying, approving a transaction for the non-fungible digital asset, the transaction occurring among at least two of the multiple nodes, thereby securing the non-fungible digital asset.

13. The computer-implemented method of claim 12, wherein the non-fungible digital asset is a non-fungible token (NFT).

14. The computer-implemented method of claim 12, further comprising:
configuring the multiple nodes to operate in connection with each other in the blockchain computer network.

15. The computer-implemented method of claim 14, further comprising:
configuring the transaction to perform a cross-chain transfer of the non-fungible digital asset between the blockchain computer network and at least one additional blockchain computer network.

16. The computer-implemented method of claim 12, further comprising:
configuring a first node of the multiple nodes to request access to a shard of the one or more shards; and
configuring a second node of the multiple nodes to delegate access to the shard to the first node.

17. The computer-implemented method of claim 16, further comprising:
configuring the second node to manage access to the shard to which the first node is configured to request access.

18. The computer-implemented method of claim 16, wherein the first node is a client device, and further comprising:
configuring the client device to interface with an online gaming environment.

19. The computer-implemented method of claim 12, wherein the transaction is a first transaction, and further comprising:
detecting at least one indication of fraud in a second transaction for the non-fungible digital asset.

20. The computer-implemented method of claim 19, further comprising, upon detecting the at least one indication of fraud:
preempting the second transaction; and
verifying the cryptographic key securely bound with the non-fungible digital asset, wherein the one or more shards include at least three shards associated with at least three respective nodes of the multiple nodes.

21. The computer-implemented method of claim 20, further comprising:
configuring at least one of the at least three respective nodes as a wallet node, a user node, or a compliance node.

22. A non-transitory computer program product for securing a non-fungible digital asset, the non-transitory computer program product comprising a computer-readable medium with computer code instructions stored thereon, the computer code instructions being configured, when executed by a processor, to cause the processor to:
execute, at least one of multiple nodes of a blockchain computer network, a multiparty computation (MPC) security system configured to:
implement a secure binding between a cryptographic key and a non-fungible digital asset;
computationally process one or more shards of the cryptographic key by assigning the one or more shards to one or more respective nodes of the multiple nodes;
computationally pair the one or more respective nodes with the multiparty computation (MPC) security system;
verify secure possession of each shard of the one or more shards by each corresponding node of the one or more respective nodes; and
responsive to the verifying, approve a transaction for the non-fungible digital asset, the transaction occurring among at least two of the multiple nodes, thereby securing the non-fungible digital asset.
